(19) United States
(12) Patent Application Publication
(10) Pub. No.: US 2009/0263682 A1
(43) Pub. Date: Oct. 22, 2009

(54) Fuel cell system and method for the operation of a reformer

(75) Inventor: Stefan Kading, Zerrenthin (DE)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: ENERDAY GMGH, STOCKDORF (DE)

(21) Appl. No.: 11/990,669

(22) PCT Filed: Aug. 14, 2006
(86) PCT No.: PCT/DE2006/001428

§ 371 Date: May 11, 2009

(30) Foreign Application Priority Data
Aug. 16, 2006 (DE) 10-2005-038-733.0

(51) Int. Cl. H01M 8/04; H01M 8/18

(52) U.S. Cl. 429/17; 429/20

(57) ABSTRACT

The invention relates to a fuel cell system comprising a re-former (10) for reacting fuel (12) and oxidizer (14) so as to obtain reformate (16) as well as at least one fuel cell (18) to which reformate (16) is fed. The reformer (10) is fitted with a reformer burier (20) and a reformer catalyst (22). Means (24) for feeding anode exhaust gas (26) of the fuel cell (18) and/or reformate (16) and/or exhaust gas (28) of an afterburner (30) mounted downstream from the fuel cell (18) are provided between the reformer burner (20) and the reformer catalyst (22). The invention also relates to a method for operating a reformer (10) to react fuel (12) and oxidizer (14) so as to obtain reformate (16).

The invention relates to a fuel cell system comprising a reformer for converting a fuel and an oxidising agent into a reformate and at least one fuel cell to which the reformate is supplied. The invention further relates to a method for operating a reformer for converting a fuel and an oxidising agent into a reformate.

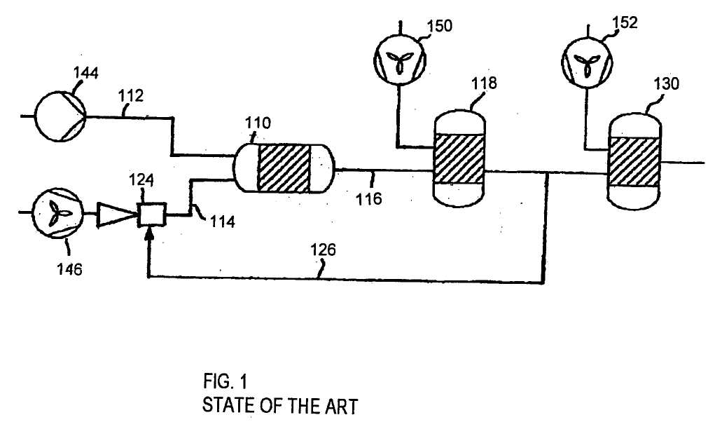

FIG. 1 shows a known simple fuel cell system designed for the use of hydrocarbons. The fuel cell system shown in FIG. 1 comprises a reformer 110 which is supplied with fuel 112 by a fuel pump 144. The reformer 110 is further supplied with an oxidising agent 114 composed of air delivered by a fan 146 and anode waste gas 126 introduced by an injector 124 in the illustrated case. The anode waste gas 126 is generated by a fuel cell 118 to which a fuel cell fan 150 is allocated and which is supplied with a reformate 116 generated by the reformer 110. The reformate 116 is a hydrogenous gas converted into current and heat with the aid of cathode air delivered by the fuel cell fan 150 in the fuel cell 118. In the illustrated case the portion of the anode waste gas which is not returned is supplied to an afterburner 130 to which an afterburner fan 152 is allocated. In the afterburner 130 a conversion of the depleted reformate together with air delivered by the afterburner fan 152 into a combustion waste gas containing low emissions of CO and NO is carried out.

In case of the fuel cell system illustrated in FIG. 1 the intake of the anode waste gas 126 is effected with (cold) air upstream of the reformer. Under unfavourable operating conditions the air/anode waste gas mixture may be combustible, may possibly ignite and may damage the reformer 110 due to the then resulting high temperatures. In a case in which the intake of the anode waste gas 126 is effected with the aid of cold air an undesirable sooting may occur.

It is the object of the present invention to further develop the generic fuel cell systems and methods so that a damaging of the reformer by igniting gas mixtures is avoided and an undesirable sooting is at least reduced as compared to the state of the art.

Said object is solved by the features of the independent claims.

Advantageous embodiments and further developments of the invention will become obvious from the dependent claims.

The fuel cell system according to the invention is based on the generic state of the art in that the reformer comprises a reformer burner and a reformer catalyst and that means for supplying anode waste gas from the fuel cell and/or of reformate and/or waste gas from an afterburner downstream of the fuel cell are disposed between the reformer burner and the reformer catalyst. In case of this solution the probability of an undesirable flame formation is at least significantly lower since the smoke gas leaving the reformer burner has a lower oxygen content than air. In the improbable case that an undesirable flame formation in the gas mixture occurs between the reformer burner and the reformer catalyst it can, for example, be readily corrected by the variation of the lambda value of the combustion in the reformer burner. Another advantage of the solution according to the invention is that the returned anode waste gas is supplied to the hot smoke gas so that at least no significant cooling of the anode waste gas gas mixture occurs whereby sooting can at least be markedly reduced as compared to the state of the art. Above that it is advantageous that a greater amount of gas is available at the outlet of the reformer burner than at its inlet due to the combustion of fuel taking place in the reformer burner whereby a larger percentage of the anode waste gas can be returned.

In the fuel cell system according to the invention it is further preferably contemplated that the means for supplying anode waste gas from the fuel cell and/or reformate and/or waste gas from an afterburner downstream of the fuel cell comprise at least one injector. The injector may, in particular, be an injector operating in accordance with the Venturi principle through which smoke gas coming from the reformer burner flows and which, for example, sucks in anode waste gas at that occasion.

The fuel cell system according to the invention may advantageously be further developed in that means for abreacting the gas present there are provided between the means for supplying anode waste gas from the fuel cell and/or reformate and/or waste gas from an afterburner downstream of the fuel cell and the reformer catalyst. In this case a smaller percentage of oxygen is present in the second mixture formation zone allocated to the burner catalyst, and a possibly disadvantageous hot spot formation in the catalyst can be avoided. Besides the high water content developing during the oxidation of the hydrogen may be advantageous for the possibly required evaporation of the fuel (for example in case of the utilisation of liquid fuels such as diesel fuel or gasoline).

In the context discussed above it is preferred that the means for abreacting the gas comprise a burner, particularly a catalytic burner. Such a burner may, like the reformer burner, be a pore burner.

In case of the fuel cell system according to the invention it is further preferred that at least two of the components comprising the reformer burner, the reformer catalyst and the means for supplying anode waste gas from the fuel cell and/or reformate and/or waste gas from an afterburner downstream of the fuel cell are thermally coupled. Particularly a thermal coupling of the components mounted in the reformer and comprising the reformer burner, the injector (possibly comprising another burner) and the reformer catalyst enables an influence on the temperature profile in the reformer catalyst or in the entire reformer which in turn may have an advantageous effect on the reforming process.

According to another also preferred further development of the fuel cell system according to the invention it is contemplated that means for tempering reformate coming from the reformer catalyst are provided. In this way it is possible to adjust the reformate coming from the reformer catalyst to the correct temperature for the following process steps. Depending on the application it is, in this case, possible to heat or cool the reformate by an apt gas guidance before it is supplied to the fuel cell.

In the context explained above it may, for example, be contemplated that the means for tempering reformate leaving the reformer catalyst comprise a heat exchanger transferring waste heat generated by the reformer to the reformate leaving the reformer catalyst. Such a heat exchanger may, for example, be formed by reformate line sections disposed (directly) adjacent to a burner associated with the reformer without being limited thereto.

According to preferred embodiments of the fuel cell system according to the invention it is contemplated that means for carrying out a lambda control of the reformer are provided. The lambda control may, in this case, be supplied as usual through a variation of the amounts of fuel or the amounts of combustion air. The means for carrying out a lambda control may, in particular, be operated in a micro processor supported way and comprise at least one lambda probe.

It is further regarded as advantageous for the fuel cell system according to the invention that the means for supplying anode waste gas from the fuel cell and/or reformate and/or waste gas from an afterburner downstream of the fuel cell are capable of carrying out a metered supply. If the anode waste gas is, for example, supplied via an injector which operates in a variable manner, i.e. is capable of adjusting the returned gas amount, the C/O ratio in the reformer can be influenced in the desired manner.

The method according to the invention for operating a reformer is based on the generic state of the art in that a section between a reformer burner and a reformer catalyst is supplied with anode waste gas from a fuel cell and/or reformate and/or waste gas from an afterburner downstream of a fuel cell. In this way the features and advantages explained in connection with the fuel cell system according to the invention are achieved in the same or a similar manner; for this reason reference is made to the corresponding explanations given in connection with the fuel cell system according to the invention to avoid repetitions.

The same applies analogously to the following preferred embodiments of the method according to the invention, reference being made to the corresponding explanations given in connection with the fuel cell system according to the invention in this case as well to avoid repetitions.

In case of the method according to the invention it is preferably contemplated that in the section the anode waste gas from the fuel cell and/or the reformate and/or the waste gas from an afterburner downstream of the fuel cell is supplied by at least one injector.

In connection with the method according to the invention it is further regarded as advantageous that the gas present after the supply of the anode Waste gas from the fuel cell and/or of the reformate and/or the waste gas from an afterburner downstream of the fuel cell is at least partly abreacted.

In this connection an advantageous further development prescribes that the gas present after the supply of the anode waste gas from the fuel cell and/or the reformate and/or the waste gas from an afterburner downstream of the fuel cell is abreacted in a burner, particularly in a catalytic burner.

At least in specific embodiments of the method according to the invention it may be contemplated that reformate leaving the reformer catalyst is tempered.

In this connection it is, for example, possible that reformate leaving the reformer catalyst is tempered by a heat exchanger transferring waste heat generated by the reformer to reformate leaving the reformer catalyst.

It is regarded as particularly advantageous for the method according to the invention that a lambda control of the reformer is carried out.

Preferably it is further contemplated in the method according to the invention that the anode waste gas from the fuel cell and/or the reformate and/or the waste gas from an afterburner downstream of the fuel cell is supplied to the section in a metered manner.

An important basic idea of the invention is that an undesirable flame formation and/or an undesirable sooting in a reformer is avoided particularly by not introducing returned anode waste gas upstream of the reformer but between a reformer burner and a reformer catalyst.

Advantageous embodiments of the invention will be explained in more detail below by way of example with reference to the accompanying drawings in which:

FIG. 1 is a schematic representation of a fuel cell system according to the state of the art already explained in the introduction; and

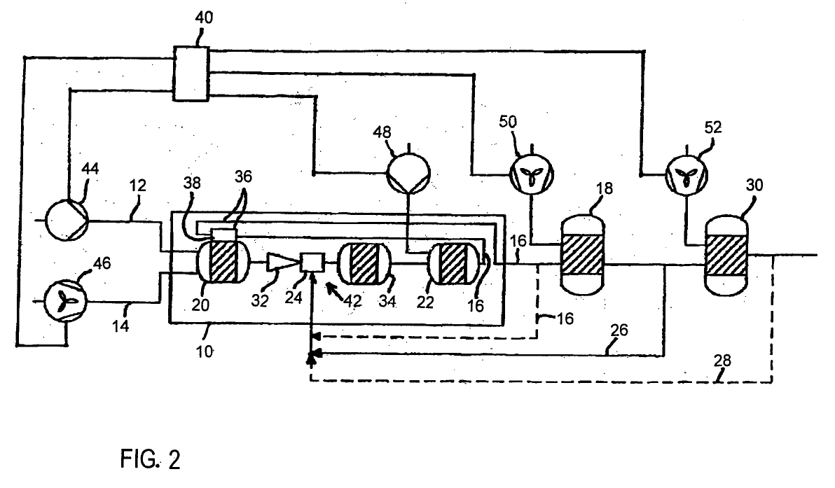

FIG. 2 is a schematic representation of an embodiment of the fuel cell system according to the invention also capable of carrying out the method according to the invention.

The embodiment of the fuel cell system according to the invention shown in FIG. 2 comprises a reformer 10 for converting fuel 12 and an oxidising agent 14 into a reformate 16. In this connection the fuel 12, for example gasoline or diesel fuel, is supplied to the reformer 10 by a fuel pump 44. In the present case air 14 supplied to the reformer 10 by a reformer fan 46 serves as the oxidising agent. A part of the reformate 16 generated by the reformer 10 is supplied to a fuel cell 18 or to a fuel cell stack, the hydrogen containing gaseous reformate supplied to the fuel cell 18 being converted into current and heat in the fuel cell 18 with the aid of cathode air supplied by a fuel fan 50. In the present case the reformate depleted by the conversion in the fuel cell 18 is supplied to an afterburner 30, for example a pore burner, to which an afterburner fan 52 is allocated.

The reformer 10 comprises a reformer burner 20 supplied with the fuel 12 and the oxidising agent 14. The reformer 10 further comprises a burner catalyst 22 to which a fuel pump 48 is allocated. Between the reformer burner 20 and the reformer catalyst 22 means 24 are provided by means of which anode waste gas 26 may be supplied to the smoke gas leaving the reformer burner 20. Additionally or alternatively it may be contemplated that said smoke gas is supplied with reformate 16 and/or waste gas 28 from the afterburner 30 as indicated by the broken lines. The means 24 are, in the present case, formed by an injector 32 operating in accordance with the Venturi principle. The injector 32 is preferably capable of varying the supplied amount of anode waste gas 26 and/or reformate 16 and/or afterburner waste gas 28. Particularly if different gasses are introduced via the injector 32 it may be advantageous to provide one or more valve devices or fans (not shown) through which the respectively supplied amount of gas may be adjusted. It is, for example, possible to influence the C/O ratio in the reformer 110 by varying the amount of the supplied anode waste gas. Even though this is not absolutely required another burner 34, for example a catalytic pore burner, is provided between the injector 32 and the reformer catalyst 22 in the embodiment shown to abreact the gas supplied to the other burner 34. Therefore a lower percentage of oxygen is present in the mixture forming zone of the reformer catalyst 22, and this contributes to the avoidance of a hot spot formation in the reformer catalyst. In addition the high percentage of water forming during the oxidation of the hydrogen may be advantageous for the possibly required evaporation of the fuel (for example in case of the utilisation of liquid fuels).

A further optional particularity of the fuel cell system shown in FIG. 2 is that the reformate 16 leaving the reformer catalyst 22 is first tempered. For this purpose means 36 in the form of lines and a heat exchanger 38 are provided, the heat exchanger 38 transferring waste heat of the reformer burner 20 to the reformate 16 to heat it so that it has a temperature optimum for the following process steps. If the reformate leaving the reformer catalyst 22 has a temperature which is too high for the following steps of the process the reformate 16 leaving the reformer catalyst 22 may be cooled by an adept arrangement of the lines. In such a case the heat exchanger 38 might, for example, be bypassed by a bypass (not shown).

In the illustrated case further means 40 in the form of a controller are provided which are capable of carrying out a lambda control of the reformer 10. A lambda control of the reformer is enabled by means of a variation of the supplied amounts of fuel or air, the current lambda value preferably being detected by a lambda probe (not shown) and taken into consideration in the control. A lambda control is particularly advantageous to prevent an undesirable flame formation in the area of the injector 32 from the beginning or to possibly stop it should the necessity arise.

The method according to the invention for operating a reformer may be carried out as follows using the fuel cell system shown in FIG. 2: The reformer 10 is provided for converting fuel 12 and oxidising agent 14 into a reformate 16. Here the reformer 10 comprises a reformer burner 20 and a reformer catalyst 22. A section 42 between the reformer burner 20 and the reformer catalyst 22 is supplied with anode waste gas 26 from a fuel cell 18 and/or reformate 16 and/or waste gas 28 from an afterburner 30 downstream of the fuel cell 18. The supply of the gas is, in this case, effected via an injector 32. The gas mixture leaving the injector 32 is abreacted by the other burner 22. A tempering of the reformate 16 leaving the reformer catalyst 22 is effected by the heat exchanger 38 transferring the waste heat generated by the reformer burner 20 to the reformate 16. The lambda control of the reformer 10 is carried out by the means 40 in the form of a controller. The injector 32 is further designed to vary the amount of gas supplied through it; if necessary further valve devices or fans or the like (not shown) may be provided for this purpose.

The features of the invention disclosed in the above description, in the drawings as well as in the claims may be important for the realisation of the invention individually as well as in any combination.

### LIST OF NUMERALS

10 reformer
12 fuel
14 oxidising agent
16 reformate
18 fuel cell
20 reformer burner
22 reformer catalyst
24 means for supplying gas
26 anode waste gas
28 waste gas
30 afterburner
32 injector
34 additional burner
36 means for tempering the reformate
38 heat exchanger
40 controller
42 section
44 fuel pump
46 reformer fan
48 fuel pump
50 fuel cell fan
52 afterburner fan
110 reformer
112 fuel
114 oxidising agent
116 reformate
118 fuel cell
124 injector
126 anode waste gas
130 afterburner
144 fuel pump
146 fan
150 fuel cell fan
152 afterburner fan

1-17. (canceled)

18. A fuel cell system comprising:
a reformer for converting fuel and an oxidising agent into a reformate, and
at least one fuel cell to which the reformate is supplied, the reformer comprising a reformer burner, a reformer catalyst and means for supplying anode waste gas from the fuel cell and/or of reformate and/or waste gas from an afterburner downstream of the fuel cell, said means disposed between the reformer burner and the reformer catalyst.

19. The fuel cell system according to claim 18, wherein the means for supplying anode waste gas from the fuel cell and/or reformate and/or waste gas from an afterburner downstream of the fuel cell comprises at least one injector.

20. The fuel cell system according to claim 18, further comprising means for abreacting gas disposed between the reformer catalyst and the means for supplying anode waste gas from the fuel cell and/or reformate and/or waste gas from an afterburner downstream of the fuel cell and the reformer catalyst.

21. The fuel cell system according to claim 20, wherein the means for abreacting gas comprises a catalytic burner.

22. The fuel cell system according to claim 18, wherein at least two of the components comprising the reformer burner, the reformer catalyst and means for supplying anode waste gas from the fuel cell and/or reformate and/or waste gas from an afterburner downstream of the fuel cell are thermally coupled.

23. The fuel cell system according to claim 18, further comprising means for tempering reformate leaving the reformer catalyst.

24. The fuel cell system according to claim 23, wherein the means for tempering reformate comprises a heat exchanger configured to transfer waste heat generated by the reformer to the reformate leaving the reformer catalyst.

25. The fuel cell system according to claim 18, further comprising means for carrying out a lambda control of the reformer.

26. The fuel cell system according to claim 18, wherein the means for supplying anode waste gas from the fuel cell and/or reformate and/or waste gas from an afterburner downstream of the fuel cell is configured to carry out a metered supply.

27. A method for operating a reformer that converts fuel and an oxidising agent into a reformate, comprising,
supplying anode waste gas from a fuel cell and/or reformate, and/or supplying waste gas from an afterburner downstream of a fuel cell, to a section between a reformer burner and a reformer catalyst.

28. The method according to claim 27, further comprising using at least one injector to supply the section with the anode waste gas from the fuel cell and/or the reformate, and/or waste gas from an afterburner downstream of the fuel cell.

29. The method according to claim 27, further comprising a step of at least partly abreacting the gas present after supplying the anode waste gas from the fuel cell and/or of the reformate and/or the waste gas from an afterburner downstream of the fuel cell.

30. The method according to claim 29, wherein the step of at least partly abreacting the gas further comprises at least partly abreacting the gas using a catalytic burner

31. The method according to claim 27, further comprising a step of tempering the reformate leaving the reformer catalyst.

32. The method according to claim 31, wherein the tempering step further comprises using a heat exchanger to transfer waste heat generated by the reformer to reformate leaving the reformer catalyst.

33. The method according to claim 27, further comprising a step of performing a lambda control of the reformer.

34. The method according to claim 27, wherein the anode waste gas from the fuel cell and/or the reformate and/or the waste gas from an afterburner downstream of the fuel cell is supplied to the section in a metered manner.
